(19) United States
(12) Patent Application Publication
(10) Pub. No.: US 2005/0156389 A1
(43) Pub. Date: Jul. 21, 2005

(54) Suction device

(75) Inventors: Chi-Wang Liang, Jhonghe City (TW); Chung-Heng Yang, Taiping City (TW)

Correspondence Address: BROWDY AND NEIMARK, P.L.L.C.;624 NINTH STREET, NW, SUITE 300, WASHINGTON, DC, 20001-5303, US

(73) Assignee: Chi-Wang LIANG, Jhonghe City (TW)

(21) Appl. No.: 10/800,614

(22) Filed: Mar. 16, 2004

(30) Foreign Application Priority Data
Jan. 19, 2004 (TW) 93101428

(51) Int. Cl. B23B 5/22

(52) U.S. Cl. 279/3

(57) ABSTRACT

A suction device includes a substrate having a plurality of apertures. In each of the apertures, an adjusting member is mounted. The adjusting member has a tube and a rim. The tube has a close inner end and an open outer end and the rim is projected from the tube and attached on a sidewall of the aperture. The tube has a gap between the inner end thereof and the rim so that air only flows through the aperture through the gap.

### BACKGROUND OF THE INVENTION

1. Field of the Invention

The present invention relates generally to an automatic machine, and more particularly to a suction device, which sucks various sizes of objects and has a function of preventing air leakage to increase the efficiency of suction.

2. Description of the Related Art

A conventional suction device has a substrate having a plurality of apertures. Objects for work are put on the substrate and the air below the substrate is extracted to provide a condition of the atmospheric pressure above the substrate much greater than the atmospheric pressure below the substrate. Therefore, the objects are sucked on the substrate firmly for work.

The conventional suction device must arrange the apertures just meeting the sizes and the sharps of the objects to make the objects sealing all the apertures, such that the suction device has a well efficiency of suction. If there is one ore more apertures not sealed, the air above the substrate flows through the substrate through the unsealed aperture and we call that “air leakage”. If there is air leakage occurred, the suction device has a poor capacity of suction to hold the objects on the substrate.

In addition, the device of extracting the air below the substrate has an air guide plate below the substrate, on which a vacuum chamber is provided and in which an airway is provided to connect the vacuum chamber and a tub to extract the air from the vacuum chamber through the airway and the tube. Because of the viscosity of air, the apertures at where proximal to the airway have a high vacuum, but the apertures at where distal to the airway have a low vacuum. In other words, the apertures of the substrate have various power of suction. The way of how to make the apertures having same power of suction is a problem that the man in this field wants to fix.

### SUMMARY OF THE INVENTION

The primary objective of the present invention is to provide a suction device, which firmly holds objects with various sizes.

The secondary objective of the present invention is to provide a suction device, which has no problem of air leakage and has a high efficiency of suction.

The third objective of the present invention is to provide a suction device, which provides a uniform suction power.

According to the objectives of the present invention, a suction device comprises a substrate and an adjusting member. The substrate has an aperture having a first end and a second end. The adjusting member is received in the aperture and has a tube and a rim. The tube has a close inner end and an open outer end and the rim is projected from the tube and attached on a sidewall of the aperture. The tube has a gap between the inner end thereof and the rim so that the first end of the aperture is communicated with the second end thereof through the gap and the outer end of the tube.

### BRIEF DESCRIPTION OF THE DRAWINGS

FIG. 1 is a perspective view of a preferred embodiment of the present invention;

FIG. 2 is a sectional view of the preferred embodiment of the present invention;

FIG. 3 is a sectional view in part of the preferred embodiment of the present invention;

FIG. 4 is a top view of the air guide plate, and

FIG. 5 is a sectional view in part of the preferred embodiment of the present invention, showing how the device works.

### DETAILED DESCRIPTION OF THE INVENTION

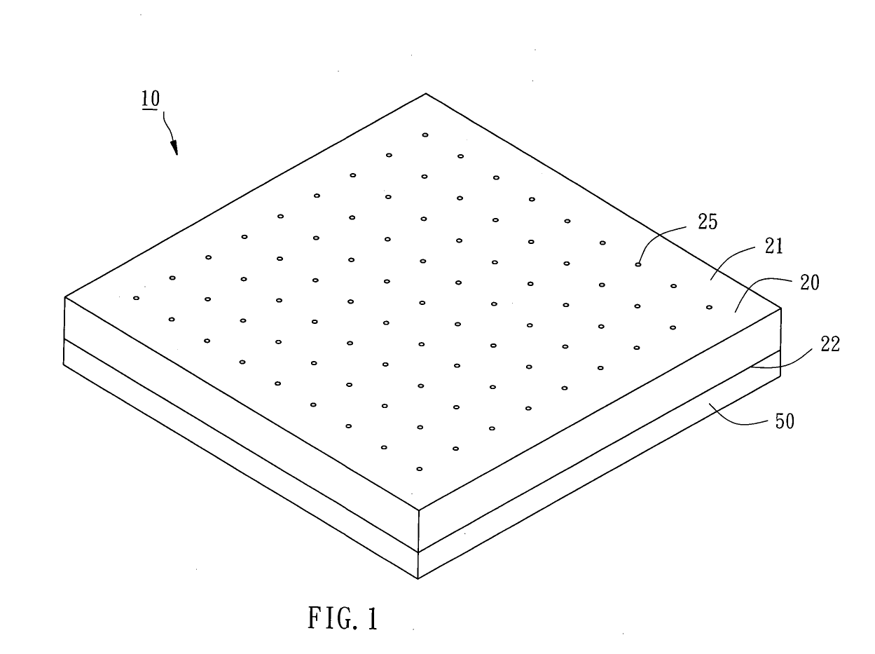

As shown in FIGS. from FIG. 1 to FIG. 3, a suction device 10 of the preferred embodiment of the present invention comprises a substrate 20, an adjusting member 30 and an air guide plate 50.

The substrate 20 has a top side 21, a bottom side 22 and a plurality of apertures 25 through the substrate 20 from the top side 21 to the bottom side 22. The apertures 25 each have a first end 23 at the top side 21 and a second end 24 at the bottom side 22. In a sectional view of the aperture 25, it has a small diameter portion 26 and a large diameter portion 27.

The adjusting member 30 has a round tube 32 and a rim 39. The tube 32 has a close inner end 33 and an open outer end 34 and the rim 39 is disposed at the outer end 34 of the tube 32. The adjusting member 30 is received in the aperture 25 with the rim 39 squeezing a sidewall of the aperture 25 at where adjacent to the second end 24. The tube 32 is smaller than the aperture 25 so that a space is left between the tube 32 and the sidewall of the aperture 25. The tube 32 has a gap 35 between the inner end 33 and the rim 39. Air only flows through the aperture 25 through the gap 35 and an airway in the tube 32. A portion of the tube 32 between the inner end 33 and the gap 35 is defined as a head portion 36 and another portion thereof between the outer end 34 and the gap 35 is defined as a fixed portion 37. A portion of the tube 32 between the head portion 36 and the fixed portion 37 is defined as a junction portion 38.

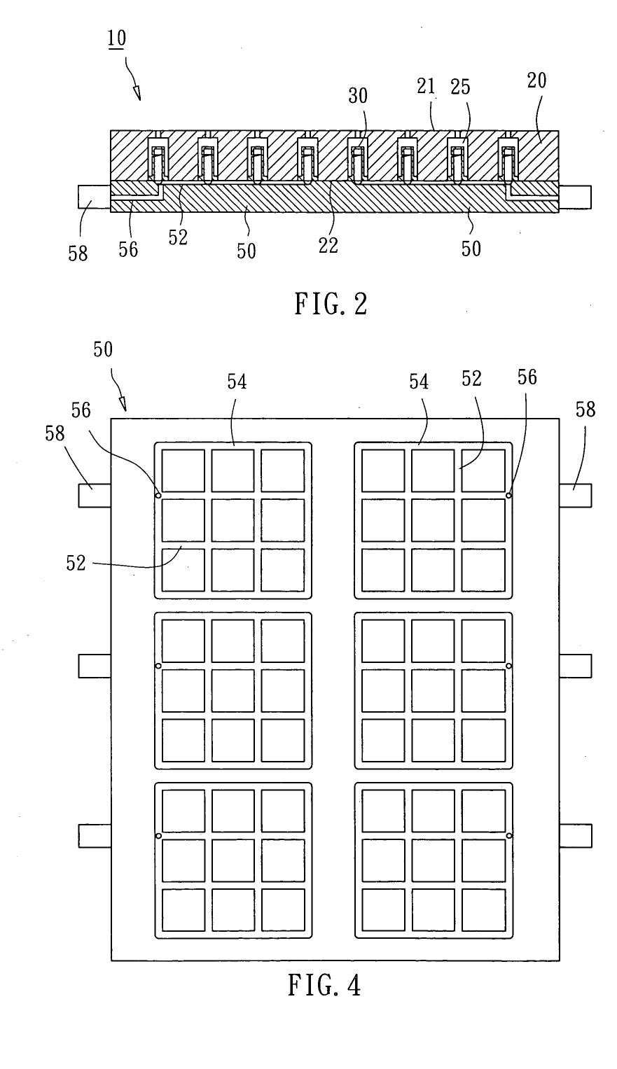

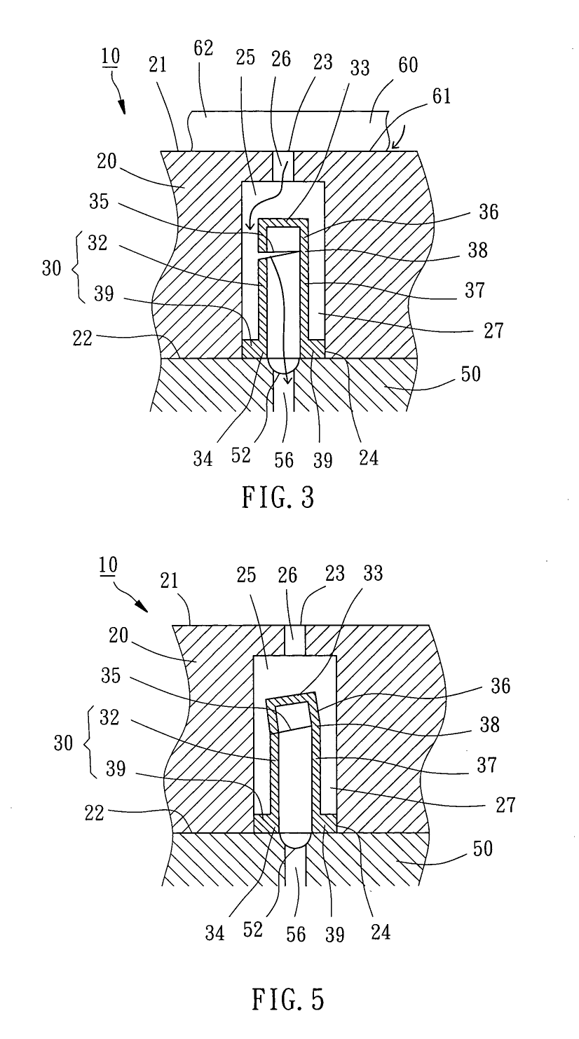

The air guide plate 50 is attached on the bottom side 22 of the substrate 20 as shown in FIG. 2, FIG. 3 and FIG. 4. The air guide plate 50 has a plurality of cross channels 52, each of which is communicated with the aperture 25 through the second end 24 thereof. The channels 52 are divided into six channel sets 54 and the channels 52 of each set are communicated with each other but are isolated from the channels 52 of other channel sets. The air guide plate 50 has airways 56 communicating the channels 52 of each channel set 54 to outside respectively. At outlets of the airways 56, connectors 58 are provided to connect an extracting device (not shown).

Objects 60 for work are put on the substrate 20 and some of the apertures 25 are covered by the objects and some of them are not. For the aperture 25 covered by the object 60, fewer air is sucked from the space between the object 60 and the substrate 20 through the small diameter portion 26, the large diameter portion 27, the gap 35 of the adjusting member 30, the outer end 34 of the tube 32, the channel 52 and the airway 56, shown as the arrows in FIG. 3. The pressure below the object 60 is far smaller than the pressure (an atmospheric pressure) above the object 60 and the pressure difference makes the object 60 being sucked on the substrate 20 firmly.

For the aperture 25 uncovered by the object 60, a great amount of air is sucked and flows through the aperture 25 through the smaller diameter portion 26, the large diameter portion 27, the gap 35 of the adjusting member 30 and the airway of the tube 32. If the air has a constant flow rate, the air has a greater speed while it flows through the gap 35 because the cross-section area of the gap 35 is smaller. According to the Bernoulli's principle, the faster the fluids run, the lower the pressure is. Therefore, the air pressure of circumstance bends the junction portion 38 and makes the head portion 36 attached to the fixed portion 37 to seal the gap 35 (in precisely, the gap 35 becomes very small). Under such condition, very little amount of air flows through the gap 35 to reduce the condition of air leakage, as shown in FIG. 5.

The apertures 25 covered by the objects 60 provides suction power to hold the objects 60 on the substrate 20 and the rest apertures 25 not covered by the objects 60, although there is a great amount of air leakage in a short period after starting sucking, are almost sealed by means of that the gap 35 of the tube 32 is closed by the fast airflow of the early period of air leakage. The suction device 10 of the present invention can switch the gaps 35 of the adjusting member 25 in the apertures 25 to an open condition or a close condition automatically according to the sizes and shapes of the objects to prevent from air leakage. The present invention also provides a high vacuum below the substrate 20 to increase the efficiency of the suction device and fix the drawbacks of the conventional device.

In addition, the present invention provides the channels 52 to replace the vacuum chamber of the conventional device. The air has to be sucked from the bottom of the substrate is less than the conventional device and that makes the efficiency increasing again. The present invention further provides the air guide plate 50 having a plurality of the channel sets 54 (the preferred embodiment has six sets, but in practice, the number of the channel sets is a choice of designer) and the airways 56 connected to the channel sets 54 respectively to extract air therefrom. That makes all of the apertures 25 having uniform suction power to fix the drawback of the conventional device.

1. A suction device, comprising:
a substrate having an aperture, which has a first end and a second end, and
an adjusting member received in the aperture and having a tube and a rim, wherein the tube has an inner end, which is close, and an outer end, which is open, and the rim is projected from the tube and attached on a sidewall of the aperture, and wherein the tube has a gap between the inner end thereof and the rim so that the first end of the aperture is communicated with the second end thereof through the gap and the outer end of the tube.

2. The suction device as defined in claim 1, wherein the rim is provided at the outer end of the tube.

3. The suction device as defined in claim 1, further comprising an air guide plate attached on the substrate, wherein the air guide plate has a channel on a side thereof to be communicated with the second end of the aperture and an airway communicated with the channel and outside.

4. The suction device as defined in claim 3, wherein the air guide plate has a plurality of channel sets, each of which has a plurality of the channels communicated with each other and each of the channel sets connect to an airway respectively.

5. The suction device as defined in claim 1, wherein the aperture has a small diameter portion and a large diameter portion; the adjusting member is received in the large diameter portion.

6. The suction device as defined in claim 5, wherein the rim of the adjusting member is attached on the sidewall of the aperture at where adjacent to an end of the large diameter portion.
